(19) United States
(12) Patent Application Publication
(10) Pub. No.: US 2014/0007595 A1
(43) Pub. Date: Jan. 9, 2014

(54) PROCESS FOR THE MANUFACTURE OF A MIXTURE OF LIQUID NITROGEN AND LIQUID OXYGEN, THE PROPORTIONS OF WHICH ARE APPROXIMATELY THOSE OF LIQUID AIR

(71) Applicant: L'Air Liquide Societe Anonyme pour l'Etude et I'Exploitaion des Procedes Georges Claude, Paris (FR)

(72) Inventors: Nadia MAYOUFI OUERGHEMMI, Bourg La Reine (FR); Patricia Privat, Magny-Les-Hameaux (FR)

(73) Assignee: L'Air Liquide Societe Anonyme pour l'Etude et I'Exploitaion des Procedes Georges Claude, Paris (FR)

(21) Appl. No.: 13/904,491

(22) Filed: May 29, 2013

(30) Foreign Application Priority Data
May 29, 2012 (FR) 1254931

(51) Int. Cl. F17C 7/02

(52) U.S. Cl. CPC F17C 7/02
USPC 62/50.1

(57) ABSTRACT

The invention relates to a process for the manufacture of a mixture of liquid nitrogen and liquid oxygen, the proportions of which are approximately those of liquid air, according to which:
first, an amount A_{N2} of liquid nitrogen (10) is transferred (11) into a mixing tank (30);
secondly, an amount A_{O2} of liquid oxygen (20) is transferred (21) into the mixing tank (30), the amounts A_{N2} and A_{O2} making it possible to reconstitute, in the mixing tank, a primary mixture within a given range of oxygen content;
the mixing tank is kept on hold for a resting period which promotes the stabilization of the mixture formed, making it possible to obtain, on conclusion of this resting period, the desired mixture.

### CROSS-REFERENCE TO RELATED APPLICATIONS

This application claims the benefit under 35 USC §119 of French Patent Application No. 1254931, filed May 29, 2012.

### BACKGROUND

1. Field of the Invention

The present invention relates to the field of processes for the manufacture of mixtures of liquid nitrogen and liquid oxygen in proportions suitable for the final applications envisaged; it is concerned very particularly with the mixtures, the proportions of which are approximately those of liquid air (for example with an oxygen content of between 18 and 25%), for well known reasons of “breathability”.

2. Related Art

It is known in particular that the use of this synthetic liquid air has been evoked as source of cold as replacement for conventional mechanical refrigerating units or as replacement for conventional cryogens (liquid nitrogen, liquid CO₂, alone or as a mixture), this being the case, for example:
in cooling tunnels for foodstuffs; and
for the refrigerated transport of foodstuffs.

In both cases, the two following situations have been described:
the mixing was sometimes preperformed before the injection (liquid air tank available on the site accommodating the tunnel or loaded under the lorry);
or else two separate liquid nitrogen and liquid oxygen tanks were available and the two cryogens were separately injected into the tunnel or the storage chamber (the vaporization thereof reconstituting a gas mixture having the approximate composition of air).

Likewise, whether it concerns tunnels or refrigerated transport, the two well known injection methods were envisaged: direct injection (spray) into the space internal to the tunnel or to the body of the lorry, or indirect injection into exchangers present in the space internal to the tunnel or to the body of the lorry.

Reference may in particular be made to the following documents, in order to better grasp this state of the art: U.S. Pat. No. 2,479,840, EP-1 069 386, U.S. Pat. No. 5,729,983, EP-836 062 or WO2011/123283.

However, the use of preconstituted liquid air (premixed liquid nitrogen and liquid oxygen) is not without presenting problems, as is known, since the mixture is not stable at the time; the liquid phase gradually becomes enriched in oxygen while the gas phase becomes enriched in nitrogen, the more volatile compound.

### SUMMARY

One of the objectives of the present invention is thus to provide a novel protocol for the manufacture of liquefied air, by reconstitution from liquid oxygen and liquid nitrogen, which offers good control of the final oxygen content thereof.

Reference is made, in that which precedes and in that which will follow, to “liquefied air” or to “liquid air” or to “mixtures, the proportions of which are approximately those of liquid air”, which should be understood by a notion covering an LN₂-LO₂ mixture, the oxygen content of which is typically between 18% and 25% but more preferably between 18% and 23.5%.

As will be seen in more detail in that which follows, the essential elements, structural and functional, of this protocol can be summarized thus:
a liquid nitrogen tank is available.
a liquid oxygen tank is available.
a main mixing tank is available, for example with a capacity which can reach several thousand litres, which mixing tank can be equipped, as conventionally, with a top condenser, with a capacity bottom evaporator and with a level sensor, the tank furthermore preferably being equipped with various liquid-phase or gas-phase drain taps, via which drain taps the oxygen content can be measured.

The tank is equipped with a liquid withdrawing line on which is positioned at least one sampling point via which the oxygen content can be analysed (analysis, for example, of capillary type).
means for determining the amounts of cryogenic fluids transferred to the mixing tank during the mixing operation are available: use may therefore be made of the bulk flowmeter but it will be preferable according to the invention to use, for this, means for weighing the mixing tank.
first, an amount A_{N2} of liquid nitrogen is transferred into the mixing tank, the monitoring of the amount A_{N2} transferred preferably being carried out by reading the weight of the mixing tank. This choice of introducing the liquid nitrogen first is advantageous; liquid nitrogen is the more volatile compound and will be in the final required mixture in a greater amount (predominant compound), this first transfer in addition ensuring that the mixing tank is kept satisfactorily cold. It may be noted here that this introduction of nitrogen can be carried out by spraying or in the bottom part (as is well known to a person skilled in the art) but preference will be given here to feeding by spraying since this method of arrival promotes the cooling of the walls of the mixing tank.
secondly, an amount A_{O2} of liquid oxygen is transferred into the mixing tank, the monitoring of the amount A_{O2} transferred preferably being carried out by reading the weight of the mixing tank, the amounts A_{N2} and A_{O2} making it possible to reconstitute the desired mixture in the tank.
while the transfers of fluids from the individual tanks to the mixing tank can be carried out, for example, via pumping means, it is preferable according to the invention to carry out these transfers by difference in pressure between the various tanks involved, this being for reasons of cost and safety but also of maintenance. It is recommended according to the invention that a pressure difference of at least 0.5 bar be maintained between the individual tanks and the mixing tank.
once the mixture has been reconstituted in the mixing tank, this mixing tank is kept on hold, a wait which can be referred to as a resting period, which promotes the stabilization of the mixture formed. According to a preferred embodiment of the invention, this resting period is maintained for several hours, for example half a day, but the tank can remain at rest for a longer time (a day, 24 hours, and the like) if the downstream use allows it.

This is because the experiments carried out by the Applicant Company have made it possible to demonstrate that the make up of the liquid phase changes virtually no more after resting for 2 to 3 h in the targeted range of make up of the mixture; consequently, a withdrawal can be made towards the downstream application without disadvantage.

By way of illustration, for an initial composition via volume of 15% [O₂] and 85% [N₂], the liquid phase of the mixture was measured as containing, after 2 h, approximately 19% [O₂]. In the following week, the O₂ content was measured as not exceeding 21%.

To sum up, it can thus be said that a “primary” mixture was reconstituted immediately after introduction of the fluids, which mixture may or may not be within the targeted range of 18-25% (and preferably within the range 18-23.5%), but that, in any case, on conclusion of the said resting period, the mixture will be found within this desired range, as is clearly shown in the above example, for the subsequent use downstream in which it is required.

During this resting time, it may be permitted to carry out one or more withdrawing operations spread out in time, in the liquid phase, and thus of very small amounts (typically, but this is only illustrative, a sampling of 0.5 l/h of liquid), which sampling thus does not disrupt the stabilization of the mixture, these withdrawing operations being carried out for the analysis of the oxygen content of the mixture.

The monitoring by withdrawing the liquid phase proves to be very useful, as can easily be understood; since the liquid air mixture thus reconstituted is intended to be subsequently transferred to a downstream use (moreover, in general, which will not be fed directly from the mixing tank but mixture will be transferred from the mixing tank to one or more secondary tanks which will be used to feed the targeted downstream application), it is therefore important for the O₂ content of the liquid transferred from the mixing tank to be suitable for the requirements of the final application.
after observing the resting period, it is possible to withdraw liquid from the mixing tank in order to direct it to the downstream application or applications: the experiments carried out by the Applicant Company have demonstrated that, during such a withdrawing operation, the oxygen content of the liquid phase remains stable and that of the liquid transferred downstream is the same as that in the mixing tank. The composition of the liquid air mixture of the mixing tank is therefore stable and not impacted by this withdrawing operation for feeding the downstream application.

The invention thus relates to a process for the manufacture of a mixture of liquid nitrogen and liquid oxygen, the proportions of which are approximately those of liquid air, according to which:
a liquid nitrogen tank is available;
a liquid oxygen tank is available;
a mixing tank, capable of storing the mixture formed, is available, the tank being equipped with a liquid withdrawing line on which is positioned at least one sampling point via which the oxygen content can be analysed;
means for determining the amounts of cryogenic fluids which will be transferred from the nitrogen and oxygen tanks into the mixing tank during the mixing operation are available;

characterized in that the following stages are carried out:
first, an amount A_{N2} of liquid nitrogen is transferred into the mixing tank;
secondly, an amount A_{O2} of liquid oxygen is transferred into the mixing tank, the amounts A_{N2} and A_{O2} making it possible to reconstitute, in the mixing tank, a primary mixture within a given range;
the mixing tank is kept on hold for a resting period which promotes the stabilization of the mixture formed, making it possible to obtain, on conclusion of this resting period, the desired mixture.

The process according to the invention can furthermore adopt one or more of the following technical characteristics:
the mixing tank is equipped with a top condenser and, during at least a part of the transfer into the mixing tank of the amount A_{N2} of liquid nitrogen, liquid nitrogen is sent into the condenser in order to condense vapour phase present in the mixing tank and thus to lower the pressure in the tank, if the need therefor makes itself felt,
the amounts A_{N2} and A_{O2} of cryogens transferred into the mixing tank are determined by the use of bulk flowmeters,
the amounts A_{N2} and A_{O2} of cryogens transferred into the mixing tank are determined by weighing the mixing tank,
the transfers of cryogens from the individual tanks into the mixing tank are carried out using pumping means,
the transfers of cryogens from the individual tanks into the mixing tank are carried out without the involvement of pumping means but by virtue of the presence of a pressure difference between these individual tanks and the mixing tank, this pressure difference being at least equal to 0.5 bar,
the resting period of the primary mixture, once formed, is between 1 and 3 hours,
the resting period of the primary mixture, once formed, is at least half a day,
the resting period of the primary mixture, once formed, is a day,
during the resting period, one or more analyses of the oxygen content of withdrawn samples of primary mixture in the liquid phase are carried out,
during the phase of formation of the primary mixture, a pressure not exceeding 1.5 to 2 bar relative is maintained in the mixing tank.

### BRIEF DESCRIPTION OF THE DRAWINGS

Other characteristics and advantages of the present invention will become more clearly apparent in the following description, given by way of illustration but without any limitation, presented in connection with the appended figures.

FIG. 1 is a partial diagrammatic view of a plant suitable for the implementation of the invention.

FIG. 2 is a table of illustrative operating conditions for performance of the inventive method.

### DETAILED DESCRIPTION

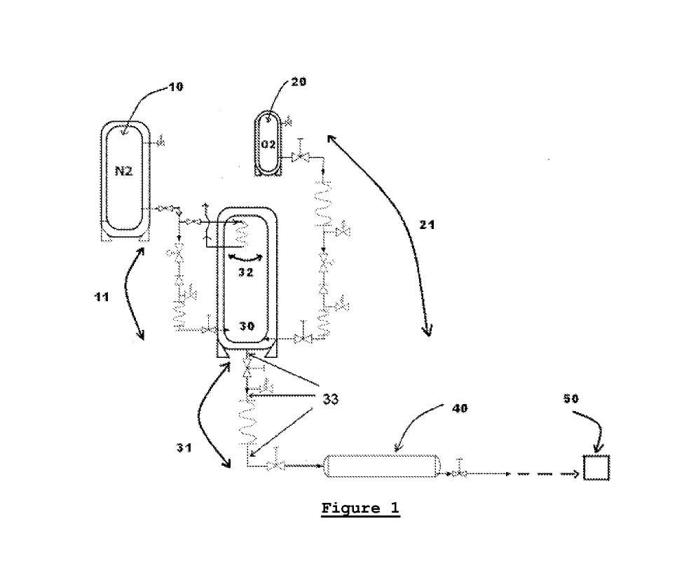

The following elements are recognized in FIG. 1:
a liquid nitrogen tank 10;
a liquid oxygen tank 20;
a mixing tank 30, which can store the mixture formed, the tank being equipped with a liquid withdrawing line 31 on which is positioned at least one sampling point 33 via which the oxygen content can be analysed. The sampling point 33 is located before or after the valve located at the outlet of the tank 30 and before or after the flexible pipe;
means for weighing the tank 30 (not represented) are available here, which means make it possible to measure the amounts of cryogenic fluids which will be transferred from the nitrogen tank 10 and the oxygen tank 20 into the mixing tank during the mixing operation;
the line 11 for transferring liquid nitrogen from the tank 10 into the mixing tank 30 typically comprises the following elements but this is only indicative: there are found, downstream of a valve, a solenoid valve, followed by a non-return valve, which, in the event of accidental excess pressure of the mixture, prevents this reconstituted mixture from returning from the mixing tank 30 to the liquid nitrogen tank 10, and then a flexible pipe which limits the stresses for the means for measuring the weight of the mixing tank, a relief valve being inserted between the non-return valve and the flexible pipe; these means are visible in the figure and are well known per se to a person skilled in the art of gases;
the line 21 for transfer of liquid oxygen from the tank 20 to the mixing tank 30 typically comprises the following elements but this is only indicative: a withdrawing or transfer valve (but, just as in the preceding case, this valve can be regarded as being an integral part of the tank 20), followed by a flexible pipe which limits, as above, the stresses for the weighing means (when weighing means are present for the tank 20 but, as was said above, it is possible to operate with weighing means solely on the mixing tank 30), which flexible pipe is followed by a solenoid valve, the solenoid valve is followed by a non-return valve, for blocking any accidental passage of the mixture reconstituted in the mixing tank 30 to the liquid oxygen tank 20, and then there is found a second flexible pipe which, for its part, limits the stresses experienced by the load cells placed under the mixing tank 30, and, finally, a valve for feeding oxygen to the mixing tank 30. Relief valves are inserted in this instance respectively between the first flexible pipe and the solenoid valve and between the non-return valve and the second flexible pipe but this is only indicative of the many configurations which can be envisaged; one or more relief valves are, in any case, placed between the two valves of the line.

Here again, these means are visible in the figure and are well known per se to a person skilled in the art of gases;
the liquid withdrawing line 31 makes it possible to feed a secondary tank 40, from which a user station 50 can be supplied with mixture;
the presence is also noted, within the mixing tank 30, of a condenser 32, which can be fed with liquid nitrogen from a drain tap on the line 11, which condenser can be used, if the need therefor makes itself felt, to lower the pressure in the tank by condensation of the vapour phase present in the tank, in particular during the filling with liquid nitrogen. The experiments carried through to a successful conclusion by the Applicant Company have made it possible to demonstrate that the use of such a condenser during the filling with liquid nitrogen makes it possible to save filling time in very substantial proportions. By way of illustration, for an overall reconstitution of 3 h 30 (N₂+O₂) with condenser, it is estimated that two hours of filling were saved.

For reasons of readability of the figure, not all the pressure or temperature sensors with which the transfer lines between the tanks and the withdrawing line, 11, 21 and 31, may conventionally be equipped have been shown either; likewise, the drain tap systems (conventional in this field) which may equip such cryogenic tanks and which make it possible to withdraw cryogen in liquid phase from the base of the tank in order to inject it by spraying in the gas phase of the tank under consideration, in order, if appropriate, to control the pressure in this tank, have not been represented.

Finally, still for reasons of readability, the safety systems which may equip such tanks and in particular the mixing tank, systems well known to a person skilled in the art, such as level sensors, or also liquid too full protection, or also alarm on liquid level sensor which may, if appropriate, order the closure of the fluid inlet valves, and the like, have not been represented.

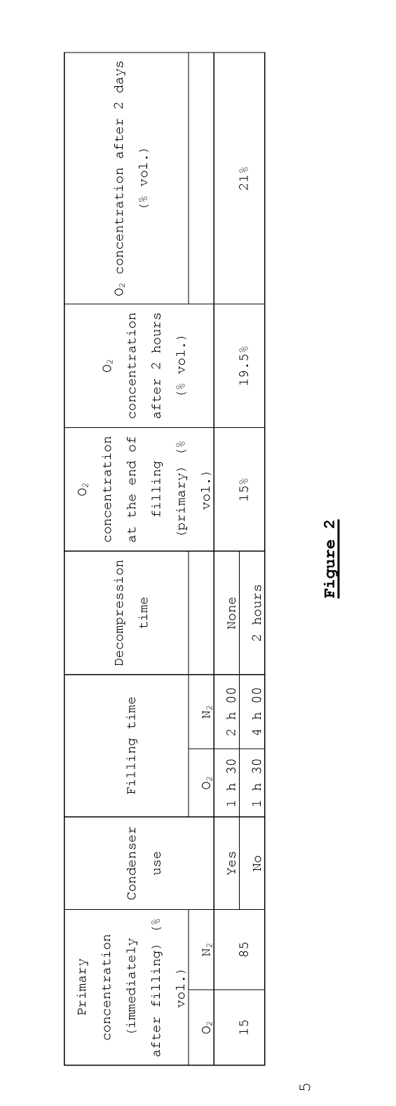

As best shown in FIG. 2, the process according to the invention was successfully used to reconstitute a charge of 2700 kg of mixture of liquid nitrogen and liquid oxygen, the proportions of which are approximately those of liquid air, under the operating conditions tabulated.

In addition, the primary compositions deployed in the mixing tank (immediately after transfer of the two cryogens), for different contents required by the final user station, are summarized in the table below:

| | |
|---|---|
| | Primary |
| [O₂] targeted | composition |

| (% vol) for final | O₂ | N₂ |
|---|---|---|
| user station | % vol | % vol |
| 18% | 13.5 | 86.5 |
| 19% < [O₂] < 21% | 15 | 85 |
| 22% | 16 | 84 |

What is claimed is:

1. Process for the manufacture of a mixture of liquid nitrogen and liquid oxygen, the mixture having an oxygen content between 18% and 25%, the balance being nitrogen, said method comprising the steps of:
transferring liquid nitrogen from a liquid nitrogen tank to the mixing tank;
determining that an amount AN₂ of the liquid nitrogen has been transferred to the mixing tank using a bulk flowmeter or a device that weighs the weight of the mixing tank and/or the weight of the liquid nitrogen tank;
transferring liquid oxygen from a liquid oxygen tank to the mixing tank, the mixing tank having a liquid withdrawing line on which is positioned at least one sampling point via which the oxygen content of liquid withdrawn from the mixing tank can be determined;
determining that an amount AO₂ of the liquid oxygen has been transferred to the mixing tank using a bulk flowmeter or a device that weighs the weight of the mixing tank; and
allowing the mixture of liquid nitrogen and liquid oxygen to stabilize for a resting period, wherein the amounts AN₂, AO₂ are sufficient to obtain an oxygen content between 18% and 25% in the mixing tank.

2. Process according to claim 1, characterized in that the amounts A_{N2} and A_{O2} of liquid nitrogen and liquid oxygen, respectively, that are transferred into the mixing tank are determined by the use of bulk flowmeters.

3. Process according to claim 1, characterized in that the amounts A_{N2} and A_{O2} of liquid nitrogen and liquid oxygen, respectively, that are transferred into the mixing tank are determined by weighing the mixing tank.

4. Process according to claim 1, wherein the liquid nitrogen and liquid oxygen are transferred using a pump(s).

5. Process according to claim 1, wherein the transfers of liquid nitrogen and liquid oxygen are carried out without use of a pump but by virtue of a pressure difference between the mixing tank and the tank from which the liquid nitrogen or liquid oxygen is transferred, the pressure difference being at least 0.5 bar.

6. Process according to claim 1, wherein the resting period is between 1-3 hours.

7. Process according to claim 1, wherein the resting period is at least half a day.

8. Process according to claim 1, wherein the resting period is a day.

9. Process according to claim 1, further comprising the steps of:
withdrawing a sample of the mixture of liquid nitrogen and liquid oxygen during the resting period; and
analyzing the oxygen content of the withdrawn sample.

10. Process according to claim 1, wherein during a period of time during which the mixture of liquid nitrogen and liquid oxygen is formed, a pressure in the mixing tank is maintained that does not exceed 1.5 to 2 bar relative.

11. Process according to claim 1, wherein the mixing tank is equipped with a top condenser and in that, during at least a part of the transfer into the mixing tank of the amount A_{N2} of liquid nitrogen, liquid nitrogen is sent into the top condenser in order to condense a vapor phase present in the mixing tank and thus lower a pressure in the tank.
